(19) United States
(12) Patent Application Publication
(10) Pub. No.: US 2014/0036088 A1
(43) Pub. Date: Feb. 6, 2014

(54) Interactive Wireless Media System

(71) Applicant: Jeffrey Gabriel, Hingham, MA (US)

(72) Inventor: Jeffrey Gabriel, Hingham, MA (US)

(21) Appl. No.: 14/040,916

(22) Filed: Sep. 30, 2013

Related U.S. Application Data
(63) Continuation-in-part of application No. 13/070,296, filed on Mar. 23, 2011, now abandoned.

(51) Int. Cl. H04N 7/18

(52) U.S. Cl. CPC H04N 7/188
USPC 348/157

(57) ABSTRACT

A wireless system for monitoring and recording of recreational activities wherein the system does not require human interaction with the field of activities. The system allows the user the ability to manipulate data retrieved with the field of activities subsequent to storage in an offsite data base and data processing center.

### CROSS REFERENCE TO RELATED APPLICATION

This application is a continuation-in-part application of U.S. application Ser. No. 13/423,928 filed on Mar. 19, 2012, and this application also claims the benefit of and takes priority from U.S. App. No. 61/508,756 filed on Jul. 18, 2011, the contents of which are hereby incorporated by reference.

### BACKGROUND OF THE INVENTION

1. Field of the Invention

The present invention relates to resort entertainment as well as sports education and primarily relates to action photography and instant access to the results thereof, for multipurpose application.

2. Description of the Related Art

Existent systems and methods for automated photo/video capture and retrieval utilize RFID (Radio Frequency Identification) tags containing a unique person and/or group identifier number. These systems allow for automated capturing and indexing of individual or group photo/video images according to each unique person and/or group identifier. Tags are worn by each park patron during their visit to the park or other entertainment facility. Various readers distributed throughout the park or entertainment facility are able to read the RFID tags. Thus, the unique identifier numbers can be conveniently read and provided to an associated photo/video capture system for purposes of providing indexing of captured photo/video images according to the unique identifiers of all individuals standing within the field of view of the camera.

### SUMMARY OF THE INVENTION

The instant invention, as illustrated herein, is clearly not anticipated, rendered obvious, or even present in any of the prior art mechanisms, either alone or in any combination thereof. A versatile container lid system, which can be quickly installed or removed and adapts to differing conditions to protect said container, adapted to compensate for the aforementioned drawbacks and limitations would afford significant improvement to numerous useful applications. Thus the several embodiments of the instant invention are illustrated herein. It is therefore a primary objective of the invention to provide an entertainment and sports education system wherein automated photo/video capture and retrieval utilize GPS systems, RFID or tags containing a unique person and/or group identifier number. These systems allow for automated capturing and indexing of individual or group photo/video images according to each unique person and/or group identifier. Tags may be worn by each park patron during their visit to the park or other entertainment facility. Various readers distributed throughout the park or entertainment facility are able to read the RFID tags or GPS transponders. Thus, the unique identifier numbers can be conveniently read and provided to an associated photo/video capture system for purposes of providing indexing of captured photo/video images according to the unique identifiers of all individuals standing within the field of view of the camera.

Our value additions are the standoff (wireless) nature of the technology and the innovative association of the video or photo and the identifying association of the customer in real time. Although this invention is being viewed on a mountain setting for everyday customers, this product is also useful for any type of entertainment resort and may also be utilized for sports education.

The instant invention lends new meaning to the expression a picture is worth a thousand words. As a result of the instant system, a service which utilizes cutting edge technology in order to ensure that real time action memories will last a lifetime. Whether it be snowboarding, skiing, downhill biking, wakeboarding, golfing, or any other recreational sport instant system, which may be known by the branding Déjà View™ offers a service like no other technology in sports growing and the constant change of technology. Further, Déjà View™ allows multiple customers to make personal hands-free movies. Déjà View customers will carry RFI technology sensing tags or GPS transponders, or sensing elements. The sensing elements trigger a network of video cameras as well as multiple shooting still-frame shots. Next, the customer's information and recordings are temporarily held on a linked computer network system. The present system affords each individual the opportunity to view and share their videos online. Additionally, at a specifically designed viewing station on the mountain, the user may also choose their recordings on a touch screen computer that instantly puts together a DVD with perfect filming cuts as, with the purchase of the sensing element, the user may be filmed or have multiple still photos taken as you naturally ride.

There has thus been outlined, rather broadly, the more important features of the versatile removably attachable container covering system in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carries out in various ways. Also, it is to be understood that the phraseology and terminology employed herein are for the purpose of description and should not be regarded as limiting.

These, together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 illustrates one mode of a readout screen for the instant system wherein a user is afforded the opportunity to process and view data from the data base;

FIG. 2 illustrates an additional mode of the readout screen wherein a user is afforded the opportunity to process and view data from the data base;

FIG. 3 illustrates a progressive readout from a filming mechanism illustrating tone genre of video which may be supplied to the readout screen wherein a user is afforded the opportunity to process and view data from the data base;

FIG. 4 illustrates a progressive readout from a filming mechanism illustrating tone genre of video which may be supplied to the readout screen wherein a user is afforded the opportunity to process and view data from the data base;

FIG. 5 illustrates one embodiment of a triggering mechanism which utilizes RFID, or other such technology, in order to commence a filming and audio sequence;

FIG. 6 illustrates embodiments of filming/audio mechanisms which work in conjunction with RFID, or other such technology, in order to film and record audio as a user moves in a sequence;

FIG. 7 illustrates one mode of an actual monitor illustrating a readout system with a screen and an example of an accompanying social network readout illustrating the integrated use of some of the media gleaned from the instant system wherein a user is afforded the opportunity to process and view data from the data base;

FIG. 8 illustrates a schematic diagram of a ski course or trial and a graphic representation of a layout of the audio/video mechanisms working in conjunction with a radiating RFID mechanism, for an RFID embodiment and further illustrates the relay of the information from audio/video mechanisms and RFID mechanisms to the database mechanism; and,

FIG. 9 is a block diagram illustrating the actions taken within an RFID system.

FIG. 10A is a diagrammatic perspective view of a SkyTRX Mini Tracker which is a small, pocket sized GPS tracking device.

FIG. 10B is a diagrammatic perspective alternate view of a SkyTRX Mini Tracker which is a small, pocket sized GPS tracking device.

### DETAILED DESCRIPTION OF THE EMBODIMENTS

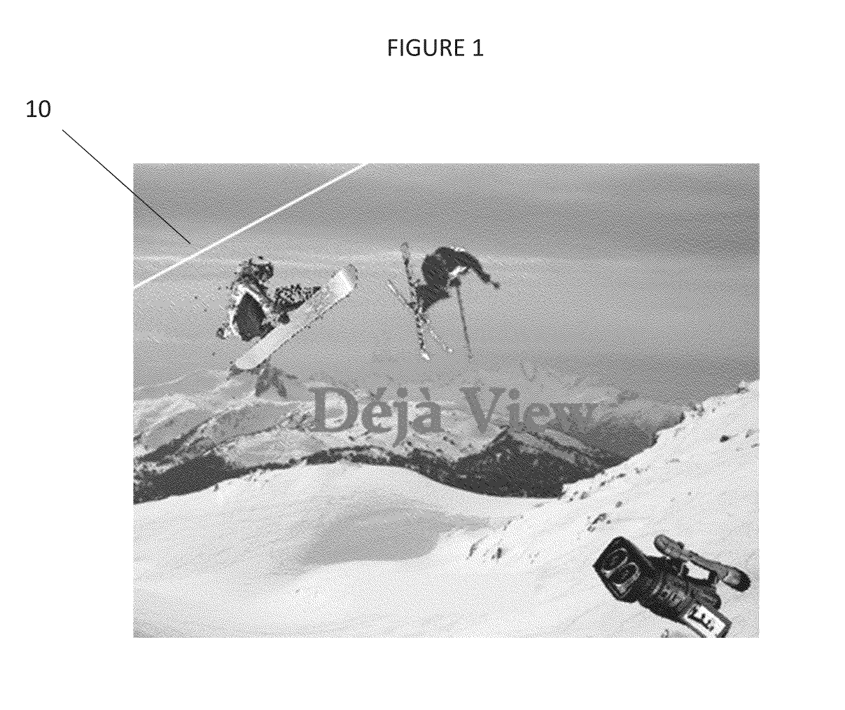

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. FIG. 1 illustrates one mode of a readout screen 10 for the instant system wherein a user is afforded the opportunity to process and view data from the data base.

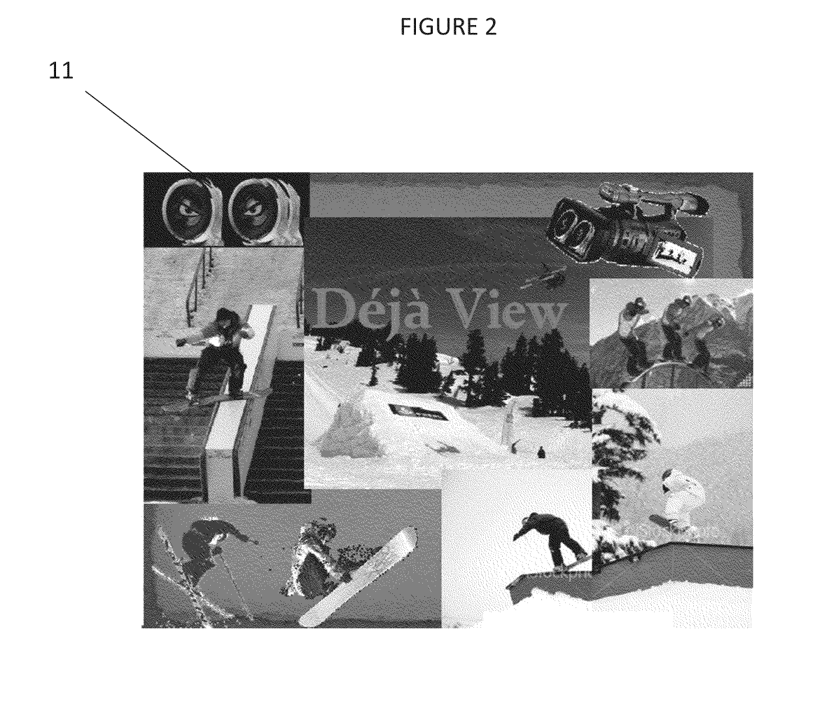

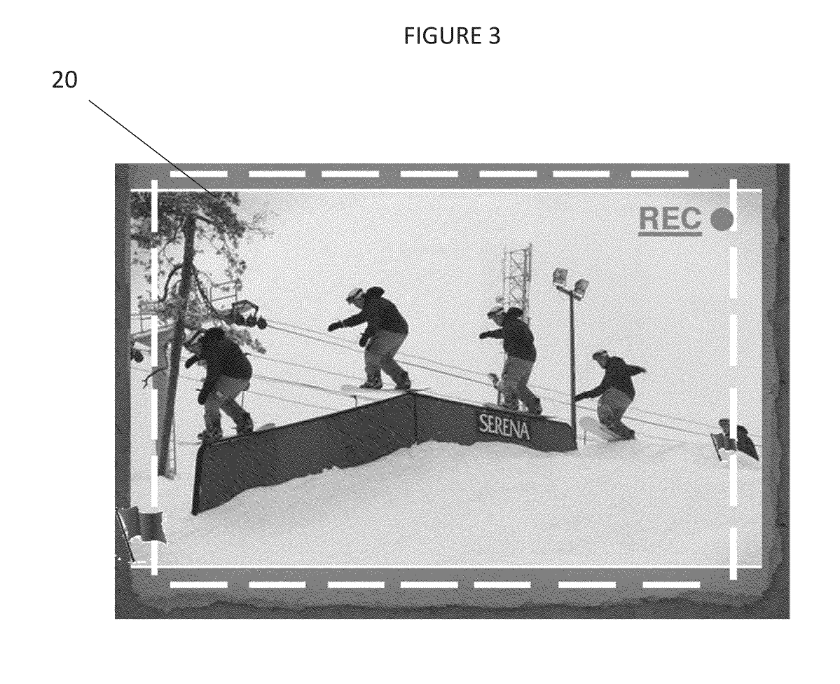

Also, FIG. 2 illustrates an additional mode of the readout screen 11 wherein a user is afforded the opportunity to process and view data from the data base. FIG. 3 illustrates a progressive readout 20 from a filming mechanism illustrating tone genre of video which may be supplied to the readout screen wherein a user is afforded the opportunity to process and view data from the data base.

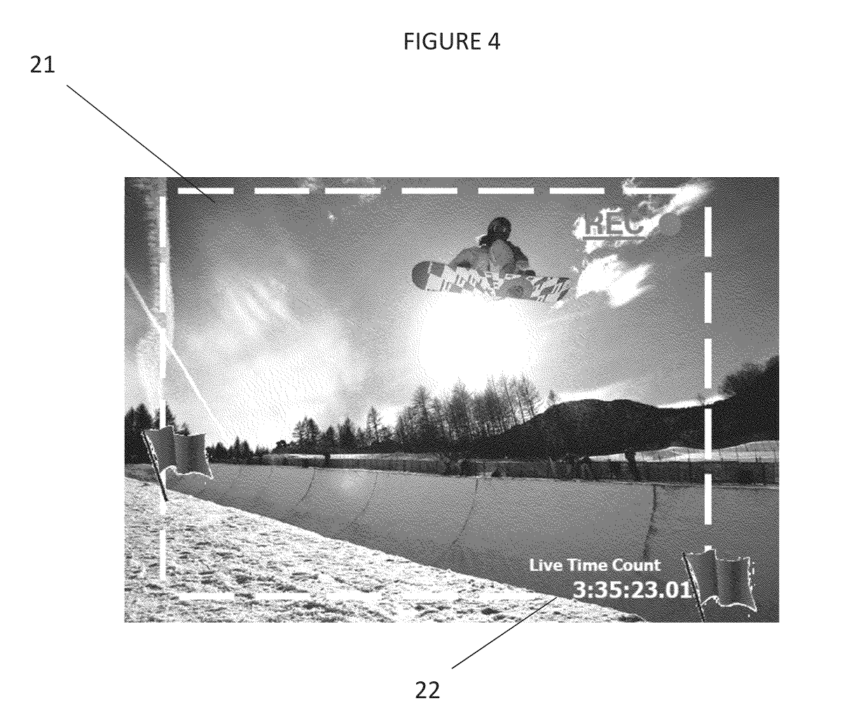

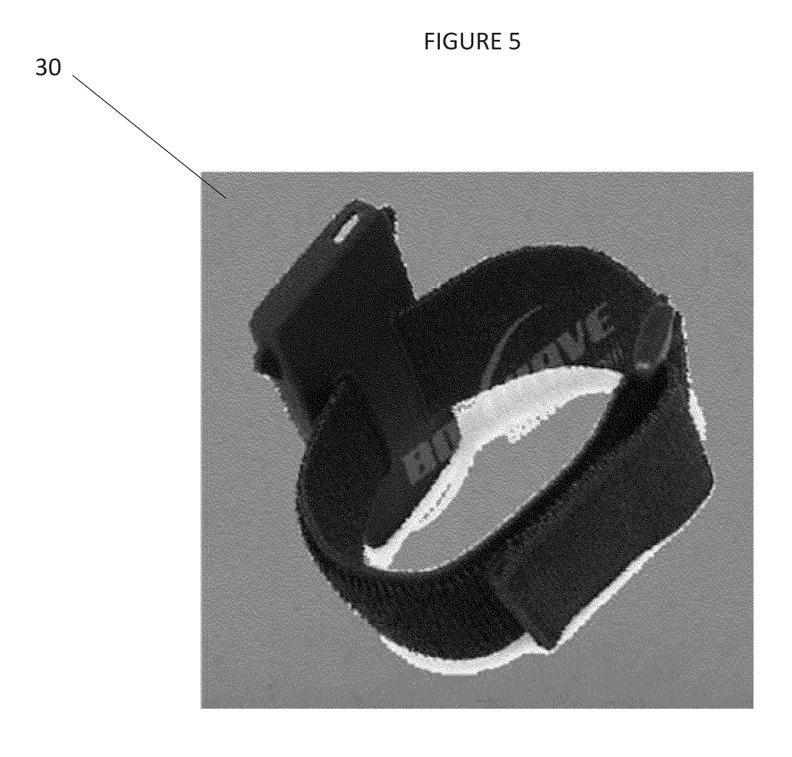

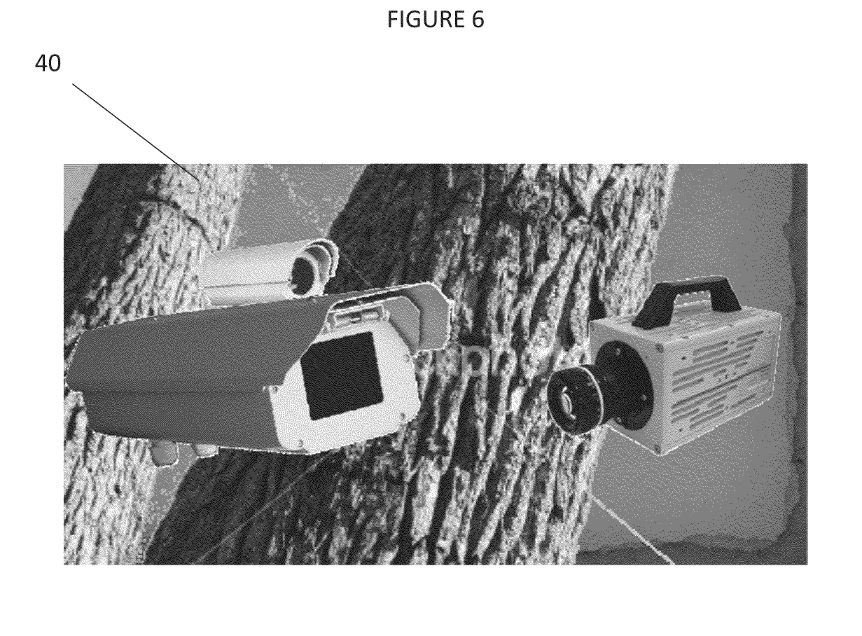

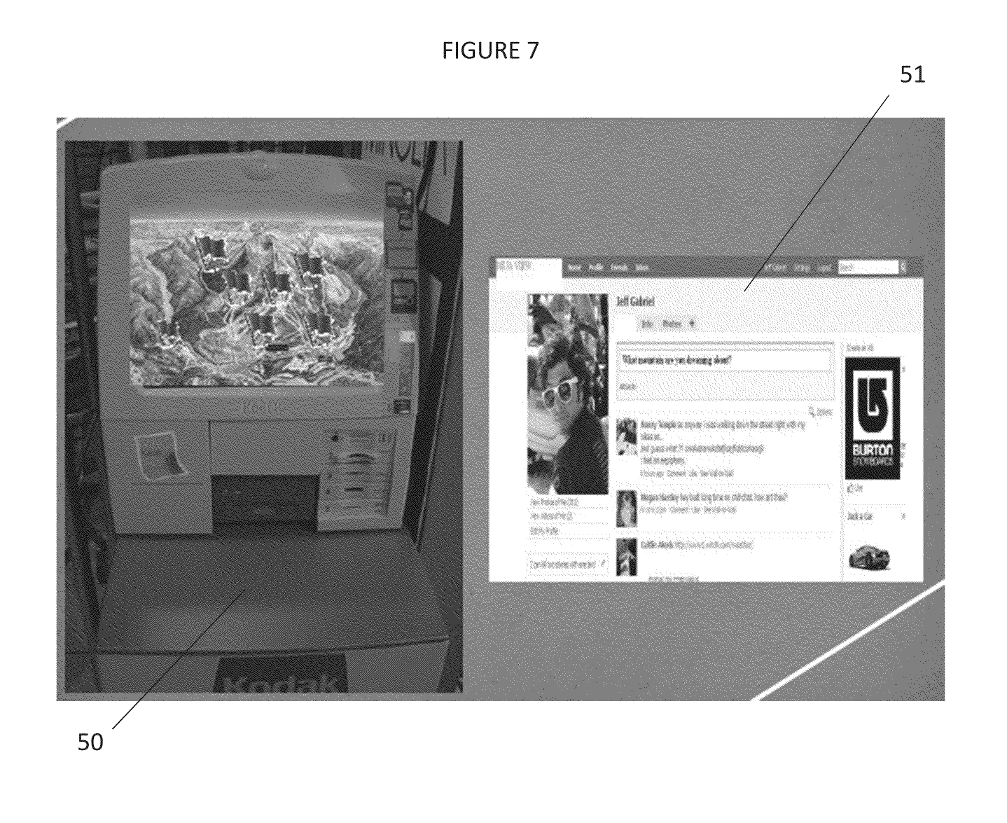

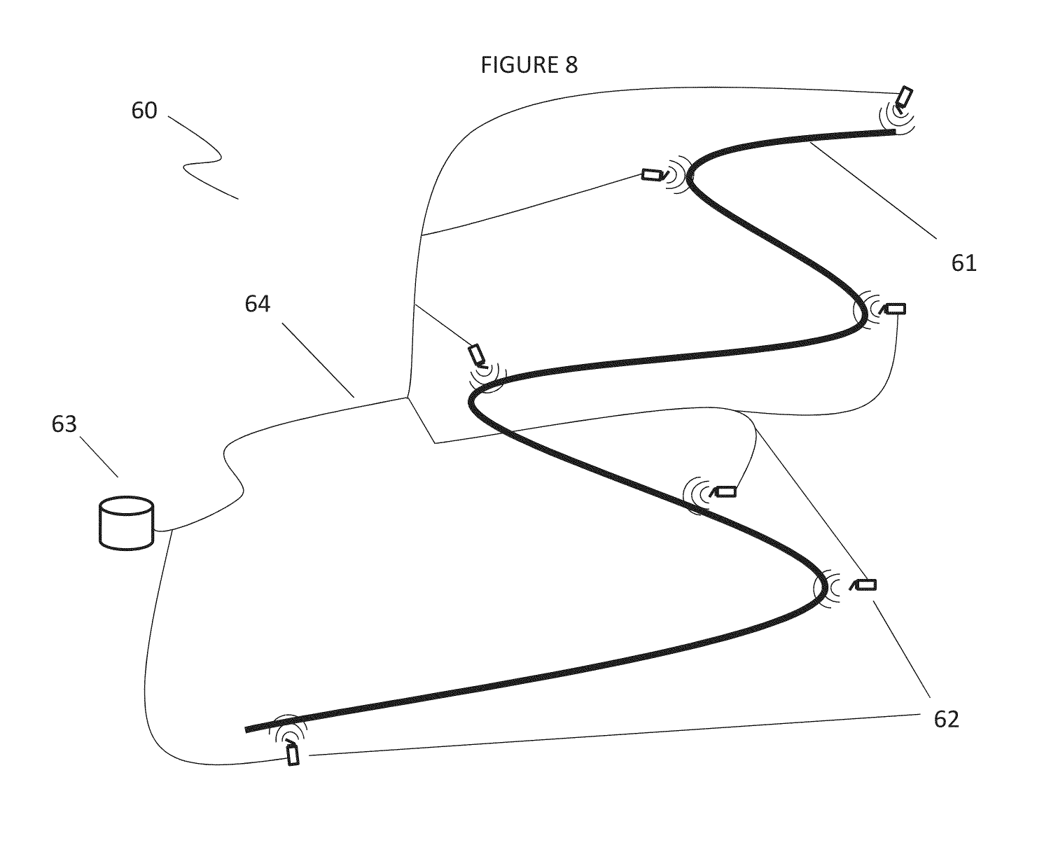

FIG. 4 illustrates an additional progressive readout 21 from a filming mechanism illustrating one genre of video which may be supplied to the readout screen, including a time counter mechanism 22, wherein a user is afforded the opportunity to process and view data from the data base. FIG. 5 illustrates one embodiment of a triggering mechanism 30 which utilizes RFID, or other such technology, in order to commence a filming and audio sequence. FIG. 6 illustrates embodiments of filming/audio mechanisms 40 which work in conjunction with RFID, or other such technology, in order to film and record audio as a user moves in a sequence. FIG. 7 illustrates one mode of an actual monitor illustrating a readout system with a screen 50 and an example of an accompanying social network readout 51 illustrating the integrated use of some of the media gleaned from the instant system (herein a photograph) wherein a user is afforded the opportunity to process and view data from the data base. FIG. 8 is a schematic diagram 60 of a ski course or trial 61 and a graphic representation of a layout of the audio/video mechanisms working in conjunction with a radiating RFID mechanism, for an RFID embodiment and further illustrates the relay of the information from audio/video mechanisms and RFID mechanisms 62 to the database mechanism 63.

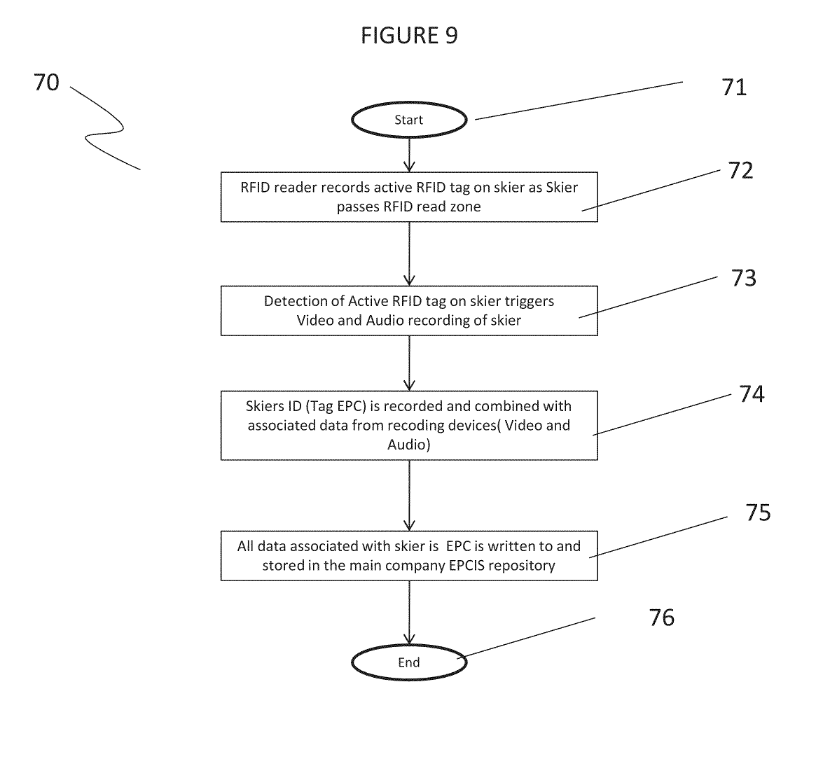

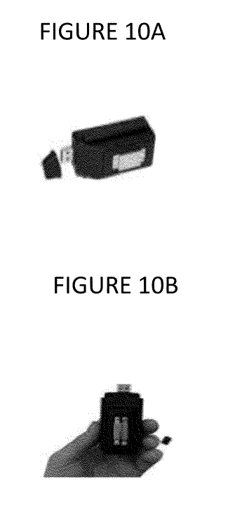

FIG. 9 is a block diagram 70 illustrating the actions taken within an RFID system as the system becomes activated. After the Initiation or Start 71 of a skier, the RFID reader records active RFID tag on skier as skier passes RFID read zone 72. Next is detection of active RFID tag on skier triggers video and audio recording of skier 73. Subsequently Skiers ID (Tag EPC) is recorded and combined with associated data from recoding devices (Video and Audio) 74. All data associated with skier is EPC is written to and stored in the main company EPCIS repository 75.

Finally, the sequence ends with the completion of the course by the skier 76. Investigating choices of equipment and configuration to be utilized, in one embodiment, the instant system may comprise a service generated through a network computer system that affords a user to employ a customized profile online. The system, which might include a patron purchasable pass, branded a Paparazzi Pass™ may comprise an RFID configuration or a GPS system that which comprises the ability to transmit a long wave frequency signal to a series of individual cameras configured on strategically chosen positions on the mountain. Each user, rider or skier will be registered to numbered RFID tag (or GPS tracker) that will connect the riders experience directly to an online social network.

The rider will wear the pass and activate the cameras by riding by the RFID sensors. Each camera will have a live feed that stores daily footage on storage apparatuses. Then perfect filming coverage may be extracted through time code. In practice, the RFID pass will alert each camera when a registered rider is position within the zone of photography. The RFID will gather the time code simultaneous with the rider entering the shot and leaving the shot. This will ensure that the correct video footage goes to the corresponding customer. Additionally, the mountain resort will also establish flags or other like markings within the existent ski courses in order to alert riders of a cameras location.

Thus, as a user approaches a camera site, the radio-frequency (RF) field emitted from the antenna activates the transponder, creating a read event. The transponder then broadcasts a signal back to the lane antenna with some basic information. Next, the information is transferred from the lane antenna to the central database, in most part via an Electronic Product Code (EPC) network. Time codes from each rider are then saved to the individual rider accounts, and the time codes which represent the individuals video, are then published to a web site for user access, namely DejaViewed.com™.

In most cases, riders will ride by the camera one at a time. Riders go on jumps and rails one at a time. Their independent time codes will be identified through their RFID pass. This system allows for friends to share their joint experience as well as share their own experience. If two customers ride in tandem, the time codes will be similar. This means the riders will receive the same footage. For example, if two friends ride the chairlift together, the footage goes to each of their online profiles. Each rider will have the same photo but they will only share the photo with the other rider if they accept each other as friends on the social network. All the footage will be accessible online for free viewing and sharing. A customer simply enters their activation code online to access their personal profile. Their profile will have a variety of personal options. A customer can view their videos and even extract photos from them and edit for further sharing with friends and family on their personal page.

Moreover, a profile may possess numerous editing options, which afford the user ability to edit videos and create their own personal short films. A person will be able to upload their own music (or from a source like iTunes) and to append preferred audio to accompany the films. Moreover, the user will be capable of commenting on other people's videos and the option to comment on their profile. The online website may be configured to accommodate advertising on each video, before, after, or during the video. The videos may also be organized by resort and date. A riders profile may have a similar profile as a friend, if they ride together, but their profile is solely customized by their riding time. A rider will be able to extend their experience by viewing it and sharing it online.

Additionally, to enhance the experience, the videos may comprise a sound component which records user conversations and exclamations during travel down the mountain. To achieve this system, a shotgun microphone will typically be used to get audio from one direction only. Thus, depending on the camera angle and depending on the type of RFID pass for specific sporting events, the amount of film time downloaded changes i.e. longer for hikers, shorter for boarders, skiers and a user would be free to edit out dead time if necessary. For example, when a rider is going off a jump, his expected recording time will be a few seconds. Extra time can be trimmed off the end of the video once the customer is online but videos will always start on time. And, a customer will also have the option to buy a hard copy of videos from the mountain.

Customers will scan their RFID pass at a computer to view their videos from that day. They will see a map on the computer screen of places they have been to. Their videos will be viewed by using a touch screen. Once the rider selects which videos they would like to keep, a DVD will instantly be put together the video. The DVD will have a simple publishing option so customers can upload them onto their computer.

An additional option may exist for the creation of an instant DVD. The computing control station may also have a jukebox option. This can give the customer the option to put music to their video. Each mountain will be able to include extra videos shots of their resort. These can be placed before and between the customer's videos. These videos may include scenery views, and or any type of advertisement the mountain wants. This program is comprised of RFID passes, RFID receivers, touch screen computers for viewing, and weatherproof boxes with solar and wind powered batteries for wipers and ventilation for the cameras. This will also ensure easy transportation if a camera location wants to be changed. Each camera will transmit the day's footage to storage devices on the mountain. If a customer wants to access their footage online, the online website will extract and save the videos from the resort's store devices and the unused videos may be deleted. A customer will also have the choice to print anything off the website. They can either send their photos to an online photo company or print them off from their own computer.

In regard to differing Passes, there will be several types of RFID passes. The different uses will revolve around the types of mountain activist. For example, a customer who only rides on trails would receive a trail pass. This pass will also have the ability to activate chairlift cameras. Another type would be for trick riding. Along from the chairlift photo ability, these RFID passes will be used in the park, on jumps, rails, or even on half pipes. Along with chairlift pictures, a customer will also have the opportunity to take photos at scenery spots. This can be used by hikers or backcountry skiers. In this case, the customer will be able to press a button on their RFID pass that will activate the camera. There will be labeled scenery spots all over the mountain. The backcountry RFID pass will activate cameras in wooded areas. There will also be cameras aimed at cliffs in bowl areas. These cliff cameras will be marked on the mountains map and will illustrate to customers which ones are being filmed.

In an additional embodiment, Déjà View™ can be operated through RFID technology as well as GPS. GPS will be used by mapping all geographical coordinates of a mountain and locations of video cameras (will organize the interaction of the GPS on mountain trails.) Once a video camera's coordinate is crossed by a GPS signal, a person will be identified through using a time code system. More specifically, the coordinates will serve as sensor points to identify the GPS carrier before they enter the camera shot and after they leave the camera shot.

In an additional embodiment, friends will be able to sign up for additional services of Déjà View™ and will have the ability to enhance their communication on the mountain and the ability to share video. In this embodiment, the mountain resort will possess RFID or GPS Helmet Cameras that can be rented for the days/weeks. These helmets will comprise installed microphones and speakers in order that friends can talk effortlessly to their friends with just one simple button. The helmet will also capture video between all the stationary cameras on the mountain. The point of this helmet is to make communication on the mountain easier and to expand the Déjà View™ experience. The helmet will have an audio system that will allow music to be played. Therefore, when an incoming call is made (by a partnered rider), the music will lower and conversation can start.

When a customer views their footage from the mountain online, the videos from the stationary cameras and the videos from the helmet camera will be in perfect order. For example: a stationary camera would record you turning the corner and then once the customer was off screen, the video footage would change directly to the helmet camera (in perfect order). This also means you will be able to view the footage of your friends if you connect with them on the Déja View™ website. The audio from the helmet will also be transferable to the online network.

This concept replaces the idea of having to enlist a person to someone follow another person with a camera. In this manner, as users ride down a mountain with friends, the group of users becomes an extension of the Déjà View™ camera network, thus assisting riders get the exclusive footage of things only their friends typically see. This will also eliminate the need to take out a video camera and the hassle of trying to get the right footage to the right person.

In an additional embodiment, titled the “Invisible Trail”, the key features allows a person who falls behind the individual or pack that are in tandem with to relocate the group. In normal circumstances, if one of a pack gets ahead of you and out of sight it becomes difficult to follow him. Riders tend to group up and wait where the trail splits which causes danger to passing riders. This also wastes a lot of personal riding time. Thus, in one embodiment, the mountain will be mapped out with sensors points where trails split into 2 directions. Once a group of friends are registered for the day (as with the helmet communication device), the group will be connected through a vibration mapping system.

Once the first friend takes a right at a split he sets the trail for his friends. When those users who are behind the lead pack users reach that same split, he will feel a vibration in his right glove or a sound in his ear to distinguish the right turn his friend made earlier. This means that friends will be able to follow the “invisible trail” of their friends and not get lost. This is one more way for friends to stay connected and enhance their time together.

In another embodiment, a Website music system may be employed. In this embodiment, a plurality of popular songs would be installed with video templates on the website. With this configuration, there would be a standard video/picture editing tool to insert your personal videos to a timeline of transitions that moves and changes with the song. There will be additional video to edit into your own personal short films.

There will be additional foot from the mountains. People may want to have scenery videos/pictures from the day they were there. These videos and pictures will more specifically show the exact conditions and of someone's day. Moreover, the instant system may be utilized in many different entertainment businesses. From scuba diving, to golf, to vacation resorts. DéjàView™ can also be used as an educational tool to teach skiers and snowboarders by visual learning. This RFID tag system works very simply as follows:

### Mountain Resort Example:

A customer can buy a “park (P-Pass) or a mountain (M-Pass) even back-country pass (BC-Pass), or a mix of all three. The diverse camera network settings allow multiple riders to experience professional athletic media coverage in different geographic segmentations.

### Stage One: Identification

Once the boundary flag is approached the video camera will start to record. This will allow each shot to have a perfect video segment from left to right or up and down. The RFI technology will automatically register the individuals' names, where exactly they are on the mountain, and how many times they've been at that point. The Camera will be able to handle multiple customers since there will be a live feed on a computer program that separates each individuals recordings according to the counts.

### Stage Two: No Pressure, Just Ride

The between points of the two flags the “Paparazzi Pass” allows your mountain experience to be naturally captured on film and still-frame movies. The clip will then be transferred to a temporary file for the rider while the rider continues to any other Déjà View in sight. The ride can have as many clips as they can get within their pass period. Thus, anything can be filmed including Jump/Trail/Rail and in long/medium/close-ups.

These boxes will allow the camera to stay active under cold snow and rain conditions. The boxes will have mini wipers to insure clear shots every time the sensor is triggered.

### Camera Type:

A high speed camera will be used to obtain the best picture quality. These cameras will have 1,000 to 10,000+ frames per second. This will allow any camera shot angle to be possible.

### End Of the Day: Online Access or Hard Copy

At the any of your experience with Déjà View™, Every customer has the option to view their videos online. When they first sign up with Déjà View™ they will be given a login name and password to their mountain video profile. Every individual will have the opportunity to view their videos online. They will also have the ability to share videos from friends and family. If you want a hard copy, you will be able to do so at the mountain's production room. The room has multiple hand touch viewing computers where the rider can Déjà View™ their day choose their individual recordings for an instant DVD.

There will be extra videos to edit into your own personal short films. There will be additional footage from the mountains. People may want to have scenery videos/pictures from the day they were there. These videos and pictures will more specifically show the exact conditions and of someone's day. To further describe the GPS embodiment, GPS transponders and other apparatuses can be employed in a manner similar to RFID for the Déjà View™ system. Specific longitude and latitudinal points will activate the time code on cameras and identify each rider with their videos/pictures. The GPS system is getting faster and faster. Déjà View™ would like to use GPS with a real time response. This will ensure accuracy and efficiency for riders.

To outline some possible configurations of GPS:

### Basic GPS INFO: SkyTRX Professional GPS Mini-Tracker Vehicle Logger

The SkyTRX Mini Tracker is a small, pocket sized GPS tracking device that receives signals from the twenty-four Department of Defense satellites orbiting the earth. The new advanced internal computer accurately determines the location of the device within 2.5 meters and records this data every second. With this data and the included SkyTRX Tracking software, users can accurately determine where a person traveled, how fast they drove, where they stopped and for how long. The recorded data from the SkyTRX Mini Tracker can be displayed over a street map, satellite images, or in a text report. Simply put, the SkyTRX Mini Tracker is an extremely affordable GPS vehicle tracking data logger system offering accurate tracking data contained within an easily deployable miniature weather resistant magnetically mounted housing. Think of it as a video recorder developed specifically to monitor and document a vehicle's traveled activities.

The Professional Skytrx Mini Tracker is perfect for tracking World Wide. Utilizing an integrated motion sensor provides the user longer battery life and more efficient mapping with Google Earth and atlas style reporting and animated mapping. No need to worry about turning the Professional Skytrx Mini Tracker on or off, once the batteries are in place the unit is on and tracking. Mini Size 3.80×1.46 x 1.34 inches, Small in size, hand held, easy to hide and to use, Internal GPS antenna, GPS indicator lights, Magnetic mount, No ON/OFF switch, Automatic low power sleep mode, No installation required, Powerful software with satellite imagery, Shows all the stops the driver makes. Includes: SkyTRX Mini Tracker and Software CD. Measures: 3.8″×1.46″×1.34″.

### Specifications

Up to 100 Hours of Data
Magnet mount
Powered by 2 AAA batteries
Water Resistant
USB connector
Motion Detection for power conserve mode
Advancements:

GPS Receivers: With the elimination of Selective Availability (SA), autonomous accuracy I much better. Today, a single stand alone receiver can provide an accuracy of between 10-15 meters. These receivers are so small that they can easily fit in your shirt pocket and one can get these receivers for approximately $100. It is also now possible with the use of DGPS service to obtain sub meter accuracy in real time. (This eliminates the need for post processing). This DGPS service is available through the use of coast guard beacon receivers and satellite base DGPS service. The coast guard service is limited to the coastal areas of the country or around 50-200 miles radius of the station itself. For areas where the coast guard beacon service is not available, real time satellite based DGPS service is available almost throughout the world at reasonable cost.

The present invention provides an improved system and method for automated photo/video capture and retrieval using unique person identifiers or RFID (Radio Frequency Identification) tags. Such system and method allows automated capturing and indexing of individual or group photo/video images according to each unique person and/or group identifier. Preferably one or more RFID tags are worn by each park patron during their visit to the park or other entertainment facility. Each RFID tag contains a unique person identifier tag with a corresponding personal number which is used to match the particular individual to any relevant captured photo images which include the individual.

Optionally, each tag may also include a unique group identifier number which may be used to match a defined group of individuals to any relevant captured photo images which include any individual(s) within the defined group. Various reader mechanisms distributed throughout the park or entertainment facility are able to read the RFID tags. Thus, the information can be conveniently read and provided to an associated photo/video capture system for purposes of providing indexing of captured photo/video images according to the individuals, and/or groups standing within the field of view of the camera.

The ability to index and retrieve captured photo images according to UPIN and UGIN provides flexibility and convenience to patrons of the park and provides increased efficiency and reduced operating costs for the facility owner. It also creates unique opportunities for further value-added image processing, products and services. For example, captured photo images may be selectively retrieved and organized into a convenient photo/video album which provides a photo record of a family's or group's adventures at the park or other entertainment facility. This can be purchased by park patrons in paper/book form or it may be subsequently accessed and/or downloaded by computer over the world-wide-web or other suitable internet system. Unique picture storybooks can also be provided using selected “gag” or “novelty” photo images taken throughout the facility and/or by using digital photo image processing to create particular desired storybook. Such picture storybooks provide amusing and entertaining reading, stories and learning for children. Serial picture books, such as simulated comic books or storybooks, may be created wherein one or more pictures and/or text passages are arranged chronologically according to a storyline in a series on a page or multiple pages so as to relate a particular story about certain characters, objects or concepts which are the subject of the story.

The present invention allows the creation of a unique interactive story book created using actual photographs/images of the park patrons or play participants themselves as they play in, on or around the facility and/or play structures. The interactive storybook relates a particular story using actual pictures and/or images of play participants (either posed or unposed) combined with other pictures, images, and/or cartoons. In this manner, the play participants themselves become actual characters in the storybook and become part of the storyline.

The present invention provides an improved system and method for automated photo/video capture and retrieval using unique person identifiers or RFID tags. Such system and method allows automated capturing and indexing of individual or group photo/video images according to each unique person and/or group identifier.

Preferably one or more RFID tags or other suitable machine-readable tags are worn by each park patron during their visit to the park or other entertainment facility. Each RFID tag contains a unique person identifier number which is used to match the particular individual to any relevant captured photo images that contains that individual. Optionally, each tag may also include a unique group identifier number which may be used to match a defined group of individuals to any relevant captured photo images that contain any individual(s) within the defined group.

In operation, using a suitable tracking system, such as bar code badges, radio frequency sensors, smart cards and/or the like, guests are tracked naturally as they ride down the hill, and are not forced to interact with specially designed interactive systems. The tags are known in the art and sold through companies like Texas Instruments, Inc. The tag is intended to be affixed or adhered to the front of a shirt or blouse worn by a park patron. The tag will contain the electronics, i.e. a spiral wound antenna, a radio frequency transmitter chip and various electrical leads and terminals connecting the chip to the antenna. The tag is activated by a radio frequency signal that is broadcast by an adjacent reader or activation device. The signal impresses a voltage upon the antenna, which is then used to power the chip. When activated, the chip transmits via radio frequency a unique identification number corresponding to the person or group.

This signal is then received and processed by the associated reader as described above. If desired, the tag may also be configured for read/write communications with an associated reader/writer. Thus, the unique tag identifier number can be changed or other information may be added to the tag, as needed or desired. In a further embodiment, the data, including any pictures, videos and the like, may be configured to be relayed and stored within a database located at a bar, pub, coffee house, restaurant, night club be or other local establishment. A video system, with capabilities can be incorporated, thus when a user's RFID can be triggered in a restaurant and pictures can be shuffled on screen with pictures. Social media networking.

In an additional embodiment, the Paparazzi Pass may comprise an application for mobile phones that uses a Bluetooth® based technology. The application automatically turns on the Bluetooth® in the phone and enables that application to interact with the Bluetooth® sensors that are placed around the venues that Deja View Concepts, Inc. at which deploys. The sensors are programmed to interact with HD IP video cameras so that users are alerted when they are in a camera zone. The user will then be able to take pictures and videos from their phone. The user will be able to preview their Bluetooth® shot by looking at their phone. The application will automatically show the correct video feed through an alert.

The PP App allows users to select different capturing modes. The Paparazzi Pass™ allows people to record pictures and videos manually and automatically. The user will be able to take a single picture, single video, multi-shot mode, burst mode, timer, and revolving timer. There will be a button on the screen to take pictures as well as an option to use the volume button on the side of the phone.

Cameras don't need to be equipped with readers, just Wi-Fi capabilities to get new daily footage that can be worked into mini-commercial templates for guests as well as extra footage to show the weather conditions from when they were there. Additionally, Filler Footage for resort advertisements, which gives customers a better all-around feel of their day, will be available.

Users will be able to trash or keep content. All the kept goods will go into their personal user library. Users will be able to edit pictures and videos by using crop, trimmers, filters, fades, transitions, and video effects such as slow motion. All open-sourced effects/filters/transitions will be used. Video filters, added filler footage, reorganizing the order of events, pulling pictures from videos, titles, and adding music through iTunes will all be options. People with the Deja View™ program would have the ability to create a 5-20 second intro of themselves before their new segment is played for friends (this is an updated version of a profile picture). Profile picture; Rotating 360 camera rotation. User stands on rotating platform with green screen. That rotating image becomes their original profile picture that spins like a video game character. Users can update their image at the resort and/or create an intro video on their profile for all their latest footage.

Users will be able to set up an Entourage. The Entourage will be a VIP list of contacts that you can share LIVE footage with. Users will be able to pick from a list of social networks as well as text and email. The entourage can be used all the time or users can quickly send out edited content to their Entourage. ex; when a friend receives a notification from someone using Deja View™, they will see their intro video (if desired) and then the most recent footage will play. The users will be able to quickly send pic/video unedited as it comes into the LIVE viewing section on the mobile app. Quick share could be your entourage or just a single email/telephone number. As well as social media sites such as Youtube®, Facebook®, Vine®, Instagram®.

The Paparazzi Pass website will also have a public section. Users can post their recent or LIVE events straight to the public site. All the public site content will be organized by location and genre. The public site will have advertising and unique contest through sponsors and individuals. Users can make up their own contest with their own rules. They can invite as many people as they want, ask for sponsors to approve the contest, and win prizes or just play for fun.

Users will be able to create their Paparazzi Profile™ page and either privately share with friends/family, or publicly share with everyone. There will be a section on Paparazzi Profile™ page for Entourage. The Entourage section will be for VIP friends/family that is allowed to view the content inside. Users could still have a public page and a private entourage.

The user library section will have three main options: Send, Create Movie/Edit, and Save. Anytime a thumbnail is clicked on, the editor is opened. Anytime the editor is open, you will be able to Add to movie (new or existing), Save (new or existing), or Share instantly. Save options will allow users to upload content to their phones camera roll, icould/cloud account, and the Paparazzi Public section.

Along with graphic overlay options for animation and titles, we will give customers the option to create unique digital shorts that will serve as unique advertisements for resorts and related products and brands looking for sponsorship opportunities and customizable add spaced based on relative content. The Paparazzi Pass™ website is also a unique advertising hub that connects users to their favorite brands and related products. Paying companies will be able to connect its brands to specific demographics based on user information (location, age, gender, profile favorites). Also, users will be able to select their favorite brands to help best represent who they are. Deja View™ will use that data to connect friends with the same products and help people find products that their friends and favorite athletes represent. Then, companies could pay to have an advertisement for those same products/styles on the same page as the users.

Along with sports, this could be used for fashion shows for real-time advertisements with complete profiles of the models and the products they are representing. This would ensure that the subscribed viewers will have access to their content and the brands/styles they were wearing and the ability to purchase instantly. Customers will have the option to receive a audio, digital, or vibration notification when they are in Paparazzi Camera™ hotspots. Users will be able to view a map of the establishment with pinpoint of camera locations. The map will be able to be viewed from satellite view, hybrid, virtual map blending (http://gizmodo.com/5371017/google-earth-will-track-cars-and-people-in-real-time-eventually-destroy-privacy).

The Premium Paparazzi Pass™ for extreme sports uses a helmet camera that connects to your phone. The Bluetooth® and GPS will be used to pinpoint where users are in relation to the mounted cameras. Customers will then have organized content from their helmet uploaded onto their Paparazzi Pass™. The content will be arranged by location, time. Users will also be able to manually shoot footage by pressing a record button attached to the outside of their clothing for easy access.

Deja View™ will also have the option to rent a camera with 360 degree filming options. In addition to Bluetooth® and RFID, the Paparazzi Pass™ will also use object and face recognition technology to track customers. Establishments with the Paparazzi Pass™ will have the option sell access/redemption codes that work on the mobile application. Also, Deja View™ will have smart vending machines around tourism areas that distribute RFID passes for people who do not have smart phones with Bluetooth®.

Paparazzi Pass™ cameras will eventually have multiple focal points when shooting video footage so people can manually focus on themselves after they have been recorded. Paparazzi Pass™ will also have access to satellite cameras to capture people in the deep wilderness to yachts. The Paparazzi Pass™ system will act as a broadcasting system for special events as well. A mobile unit will deploy at special events from amateur to professional sports, contest, concerts, and miscellaneous high volume attractions.

Friends, fans, and family can view each other in real-time on the computer or from their phones. The smart phone and smart device application allows friends to stay connected like never before. It gives customers the option to view their experience instantly: golfers can view their swing with frame by frame motion analysis, skiers and snowboarders can play life-like video games that are pre-organized and edited by Deja View™. This smart surface application is also a great tool for busy parents to stay connected with family activities.

The smart phone application for professional sports will also be a new experience for fans. Golf fans can follow the GPS/Paparazzi Pass™ location of their favorite golfer on a digital map. Smart phone and device subscribers will be notified when their golfer is approaching a desired camera shot. In addition, NASCAR fans can follow the race like never before with the ability to truly direct their own television.

Deja View™ is an exclusive marketing opportunity for broadcasting companies to expand its current revenue stream and enhance the value of the customer's experience. Deja View™ provides organized sports media coverage by using Bluetooth®, RFID, object recognition, and GPS technology. The Deja View™ system will allow subscribers to follow their favorite athletes like never before. Applications of the system in education applications will also use one or a combination of object recognition, Bluetooth®, GPS, and RFID. Applications of the system in sports fields include:
Sports Motion Analysis: 50-500-1000 frames per second. High frame rate visual analysis to enhance individual and team performance in such sports as
Golf
Track: high jump, long jump, sprinting and such other activites.
QB throwing
Crew rowing
Basketball shooting (free throws)
Baseball pitching
Organized practice/game footage
Football: organized clips from practice for coaches and players. A football player can review all the plays before game time from anywhere. (from the snap to when the play is dead, each clip has its own thumbnail with time and play reference).
Athletes can be tracked on the field which can give coaches a great advantage when teams go over practice and game footage.
   By applying software that maps a player's route and overlapping video footage, coaches and players will be able to see where they are inconsistent.
Player profiles can also be used to measure the athlete's progress. From being timed on the 50 yard run to game statistics the Deja View system allows athletes to capture their college career like never before.

### Business School/Visual Education

Class presentations, video training for business students; work on a speech or group presentations. Organized footage for teachers and learning tool for students looking to improve to the highest quality their university can offer.

Visual analysis for students using motion analysis software for high frame rate physics experiments. Just wave the credit card sized RFID card at station or podium and register your group and/or project to the presentation being recorded. Also use your smartphone or object recognition to receive the same results. Visual learning with state of the art technology.

### Campus Safety:

Campus Safety would have a computer with a full screen of the campus with a Bluetooth® /GPS signal from students, who wish to have more security, walking from their current location to the desired location. If the students signal went off track and it was linked to a car that fled from campus. The campus security would have a real-time system to view a camera or location where the car could be identified with the students GPS trail. In case of kidnapping or missing people, this would ensure the safety of students.

In another embodiment, a smart phone application is disclosed. As an example, it's 3 am and a girl wants to walk back to her dorm from across campus and feels unsafe. Shen then takes out her phone, alerts campus safety that she is walking back to her registered dorm by using her campus safety smart phone application, and she now has extended supervision on standby in case something were to happen. If she happened to get a ride from a friend half way through her walk and then decided to leave campus and not go to her dorm then the campus safety would automatically call her and make sure everything is okay (just like an ADT security system). The smart phone application would be very easy to use; simply click your destination on a campus map or from a list of dorms and sent out alert to campus safety without making a call.

### Campus Events:

Students can use their smart phones to stay connected to the Sports Zone mobile application. If you are a parent, friend, or guest of Ball State and attend a football game or event, there can be a Deja View™ mobile application for pure entertainment. Watch a time-lapse of you and friends tailgating, highlights from the game (the teams running out onto the field), stock footage advertising Ball State and sell advertising space. The Deja View™ ‘sports center’ application for students to great way for students to stay connected and receive the greatest and latest news from Ball State sports. Athletes can share footage to their family and fans from practice or games.

### Paparazzi Radio™

Be anywhere, say anything, and be heard. Paparazzi Radio only uses your microphone and location so you can broadcast your own station to friends. Use sound effects, take calls, screen calls (for emergencies), and play music for friends from playlist. Pick which advertisements you would like to use between segments/shows. Broadcast funny conversations with friends or start your own hotline for advice, the conversation is up to you. You can post related pictures or videos at the time of your segments or just keep the show restricted to audio. This content can be used to drive your Paparazzi Public profile from events, sports, places you've been.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein. All of the herein described embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed

What is claimed:

1. A system for real time action capturing, processing and viewing comprising:
a user device;
a set of Bluetooth® driven sensors;
a Bluetooth® driven mobile application on the user device;
an automated mechanism that actuates the Bluetooth® driven mobile application within the user device and enables the Bluetooth® driven mobile application to interact with the Bluetooth® driven sensors;
a series of HD IP video cameras;
an interlinked series of differentially located individual photographic devices in electrical communication with an electronic servo mechanism disposed to receive signals from a plurality of proximity devices, wherein when an individual of said plurality of proximity devices triggers said electronic servo mechanism which triggers each of said differentially located individual photographic devices when each of said differentially located individual photographic devices approaches a system defined distance;
a photographic data receiving system in communication with a set of output signals from said interlinked series of photographic devices in electrical communication;
a signal conditioning system in communication with said photographic data receiving system disposed to create a set of electronic photographic images;
a server mechanism and a data storage mechanism in communication with said signal conditioning system, said server mechanism and said data storage mechanism disposed to process and store said set of electronic photographic images; and,
a user accessible input/output mechanism disposed to afford a user access to said server mechanism and said data storage mechanism set of electronic photographic images.

2. The system for real time action capturing, processing and viewing of claim 1 wherein the electronic servo mechanism comprises an RFID driven system.

3. The system for real time action capturing, processing and viewing of claim 1 wherein the electronic servo mechanism comprises a GPS driven system.

4. The system for real time action capturing, processing and viewing of claim 1 wherein the system publishes said set of electronic photographic images onto a social network.

5. An automated photo capture and retrieval system for automatically capturing and indexing photo images of multiple individuals or groups of individuals within an alpine terrain comprising: one or more tags adapted to be worn by each individual or group of individuals desired to be photo imaged, each tag comprising an individual classification mechanism for identifying an individual registered for said systems and a group classification mechanism which may be used to match a defined group of individuals to any relevant captured photo images that contain any individual(s) within the defined group; one or more cameras distributed throughout the facility adapted to automatically capture photo and/or video images of one or more individuals in the field of view of the camera; one or more readers distributed throughout the facility and associated with each camera, each said readers being adapted to read each tag of each individual substantially within the field of view of each associated camera and to determine the unique person and/or group identifier for each tag; and an image processor to receive each captured photo image and all associated unique person and/or group identifiers and to record or each captured photo image and associated unique person and/or group identifiers such that each image may be retrieved according to its associated unique person and/or group identifiers and wherein a user may access and manipulate said photos instantly upon capture of said photo.

6. The automated photo capture and retrieval system of claim 5 wherein said tags comprise one or more RFID tags.

7. The automated photo capture and retrieval system of claim 5 wherein said tags comprise one or more GPS tags.

8. The automated photo capture and retrieval system of claim 5 wherein each RFID tag may be read over a read distance in a range between 2 feet and 100 feet.

9. The automated photo capture and retrieval system of claim 5 wherein said system can read and process a plurality of rapidly moving targets simultaneously.

10. A method for sharing content generated by a content creator within an activity, the method comprising the steps of:
downloading a mobile application from a shared network environment onto a user device;
creating a profile by the user through the mobile application on the user device;
processing the profile by the mobile application to allow the user to remain anonymous;
uploading the profile to a central database server from the user device through an external network;
obtaining a set of content through utilization of a set of Bluetooth® sensors wherein the set of content; and,
transmitting a set of content for distribution from the central database server to the mobile application on the user device.

11. The method for sharing content generated by a content creator within an activity of claim 10 wherein the set of content comprises a set of audio files and a set of video files.

12. The method for sharing content generated by a content creator within an activity of claim 10 wherein the mobile application allows the user to store and remove pictures and videos from their phone.

13. The method for sharing content generated by a content creator within an activity of claim 12 wherein the mobile application allows the user to preview a Bluetooth® picture and video from the user device.

14. The method for sharing content generated by a content creator within an activity of claim 10 wherein the mobile application comprises an alert mechanism to automatically show the correct video feed.
